(19) United States
(12) Patent Application Publication
(10) Pub. No.: US 2019/0338989 A1
(43) Pub. Date: Nov. 7, 2019

(54) Linear Actuation System Having Face Coils and Side Coils for Armature Travel Assist

(71) Applicant: ThermoLift, Inc., Stony Brook, NY (US)

(72) Inventors: Erik Kauppi, Ann Arbor, MI (US); Theodore H. St. George, Ann Arbor, MI (US)

(73) Assignee: ThermoLift, Inc., Stony Brook, NY (US)

(21) Appl. No.: 15/967,613

(22) Filed: May 1, 2018

(51) Int. Cl. F25B 9/14; H02K 33/12; H02K 11/21; H02K 11/33; F02G 1/044

(52) U.S. Cl. CPC F25B 9/145; H02K 33/12; F02G 1/0445; H02K 11/33; H02K 11/21

(57) ABSTRACT

A gas-fired heat pump has been built with a mechatronic system. Stators (a coil in a back iron) are provided at the ends of travel to draw armatures which are coupled to displacers from one end to the other. It has been found that such a system requires high current flow to draw the displacer when it is at a great distance from the stator. Additionally, it has been found to be difficult to control the current in the coils to ensure a soft landing. A linear actuation system is disclosed in which in addition to the stators at the end of travel (face stators) side stators are provided along the travel to control the linear actuator particularly during mid-travel.

### FIELD OF INVENTION

The present disclosure relates to linear actuators.

### BACKGROUND

Vuilleumier heat pumps have been known since the early 20th century. Such heat pumps, as disclosed in U.S. Pat. No. 1,275,507, have two displacers that separate the internal volume into hot, warm, and cold chambers. The displacers are crank driven with a 90 degree offset. In a more recent development, the displacers in the heat pump are by a mechatronic system, as described in commonly-assigned PCT/US16/57755. In FIG. 1, based on a figure in the '755 reference, a heat pump 100 has a hot displacer 102 and a cold displacer 104 that reciprocate within a cylinder 106. Displacers 102 and 104 are controlled by mechatronic actuators in the lower half of the heat pump 100. The actual connections are shown in FIG. 1, although not separately described. A hot displacer actuator 110 and a cold displacer actuator 120 are coupled to the hot and cold displacers 102 and 104, respectively. Each of actuators 110 and 120 have a ferromagnetic bucket, 116 and 126, respectively. Ferromagnetic buckets 116 and 126 act as armatures. Armature 116 has a plate portion that extends outwardly from a cylindrical portion through which a spring 124 passes and to which a spring 114 is coupled. Spring 114 is associated with hot displacer 102; and spring 124 is associated with cold displacer 104. An armature 126 has a plate portion and a cylindrical portion to which springs 114 and 124 are coupled. Springs 114 and 124 are, in this example, springs that go between compression and tension as the displacer to which it is coupled moves between ends of travel. Alternatively, two compression springs can be provided per displacer with the spring pair acting in opposition to each other.

Actuator 110 has coils 112 and 118 on either side of armature 116. When coil 112 is activated, armature 116 is attracted toward coil 112. When coil 112 is deactivated spring 114 causes armature 116 (and displacer 102) to move downward. If coil 118 is then activated, it attracts armature 116 toward coil 118. By deactivating coil 118, spring 114 causes armature 116 to move toward coil 112. By acting on armature 116 coupled to displacer 102, displacer 102 is caused to reciprocate between two ends of travel within cylinder 106. Similarly, displacer 104 is caused to reciprocate between its two ends of travel by judicious actuation of coils 122 and 128 that are disposed on either side of armature 126.

Herein, coils 112, 118, 122, and 128 are called face coils. They exert and attractive force on their respective armature (116 or 126) in a direction that is substantially in a direction parallel to a central axis 108 of heat pump 100. Herein such a configuration is called a face coil.

In heat pump 100, displacers 102 and 104 separate the volume with cylinder 106 into four volumes: a hot volume 140, a hot-warm volume 142, a cold-warm volume 144, and a cold volume 146.

FIG. 1 shows an example a full heat pump. As the present disclosure is about linear actuation, a simplified drawing of a linear actuator to drive a single displacer, or any other reciprocating member, is illustrated in FIG. 2. A cylinder 10 having a central axis 25 has a displacer 12 disposed therein. Displacer 12 is coupled to a shaft 14 that is coupled to a plate, which acts as an armature 16. Displacer 12, shaft 14, and armature 16 reciprocate within cylinder 10. A first face stator, which includes a coil 20 disposed in a recess in a back iron section 18, is coupled to or affixed to cylinder 10 above armature 16. A second face stator, which includes coil 22 disposed in a recess in a back iron section 19, is coupled to or affixed to cylinder 10 below armature 16. Compression springs 36 and 38 act on armature 16 in opposition to each other. When coil 20 is activated by providing current, armature 16 is drawn toward coil 20 and spring 36 is further compressed while spring 38 is less compressed. When coil 20 is deactivated, the more compressed spring 36 pushes on armature 16 causing it to travel toward coil 22. Coil 22, if activated, pulls armature 16 in and holds armature 16 until coil 22 is deactivated. Spring 36 is provided around shaft 14 and held between a bridge 30 that extends across cylinder 10. Bridge 30 has an opening 32 that is slightly greater in diameter than an outer diameter of shaft 14 to allow shaft 14 to reciprocate therethrough and to provide guidance for shaft 14. Spring 36 is captured between armature 16 and bridge 30. Armature 16 doesn't have a shaft extending downwardly, so a solid bridge 34 can be provided across cylinder 10 to capture spring 38 between armature 16 and bridge 34. In alternative embodiments, bridge 34 has a central opening to accommodate a shaft or other components.

Problems encountered with the linear actuation system shown in FIGS. 1 and 2 include a very large current through the coil to attract the ferromagnetic plate or armature when it is far away from the coil; and the difficulty in controlling the trajectory so that the displacer approaches the far end of travel and does so with an acceptably low impact speed to achieve a soft landing to thereby minimize noise. In FIG. 3, the attractive force as a function of the gap between the coil and the armature is shown for a range of current levels. At a small gap, for a given current level, the attractive force is great. As the gap is greater, the attractive force is very small. To have an effect on an armature that is far away, the current applied must be great. Another solution is to provide a coil with more windings; however, this is limited by packaging constraints and transient response of the coils.

### SUMMARY

To overcome at least one problem in the prior art, a linear actuator is disclosed that includes: a substantially cylindrical back iron section having a central axis, the back iron section having at least first and second recesses defined therein. The first recess is displaced from the second recess in a direction parallel to the central axis. The actuator further includes an armature disposed within the back iron section. The armature is free to move along the central axis between a first end of travel and a second end of travel. The actuator further includes a first face stator delimiting the first end of travel of the armature, a second face stator delimiting the second end of travel of the armature, and first and second side coils each having inner dimensions that allow the armature to pass therethrough. The first side coil is disposed within the first recess in the back iron; and the second side coil is disposed within the second recess in the back iron. In an alternative embodiment, the cylindrical back iron includes a first portion with the first recess and a second portion with the second recess. The first and second portions are contiguous.

The armature further includes a shaft extending outwardly, the shaft being parallel to the central axis.

In some embodiments, the linear actuator further includes a first compression spring disposed therein, the spring exerting a force between the armature and the back iron section. The force acts in a direction parallel to the central axis. The linear actuator also has a second compression spring that exerts a force between the armature and the back iron section with the force acting in a direction parallel to the central and opposed to the force exerted by the first compression spring.

Other embodiments include a spring indirectly coupled between the armature and the back iron section. The spring is in compression when the armature is at the first end of travel and in tension when the armature is at the second end of travel. Indirectly coupled to the armature herein means coupled to an element that is coupled to the armature, such element, e.g., being a shaft or a plate that is coupled to the armature.

The first and second face stators each have a face back iron having a recess therein and a face coil disposed within each recess.

The armature is comprised of one of: a ferromagnetic material and a permanent magnet.

Also disclosed is an apparatus that has: a cylinder having a central axis, a reciprocating component disposed in the cylinder, a shaft coupled to the reciprocating component, and a linear actuation system. The linear actuation system includes: a armature coupled to the shaft. The armature has a first end of travel delimited by a first face stator and a second end of travel delimited by a second face stator. A path of travel from the first end to the second end is parallel to the central axis of the cylinder. The linear actuation system further includes a side stator disposed between the first and second face coils. The side stator has an inner diameter greater than an outer diameter of the armature.

In some embodiments, the armature is indirectly coupled to the shaft, with a yoke coupled between the armature and the shaft.

In some embodiments, the apparatus includes a first compression spring that exerts a force pushing the armature away from the first face stator and a second compression spring that exerts a force pushing the armature away from the second face stator. That is, the springs provide forces acting in opposition. In some embodiments, the compression springs act directly on the armature. In other embodiments, the compression spring acts upon an element coupled to the armature, such as the shaft or a plate coupled to the shaft, i.e., any reciprocating element. The other side of the spring acts upon a stationary element associated with the apparatus such as the cylinder, one of the stators, bridges, or any other suitable element.

In some embodiments, a compression-tension spring is disposed within the linear actuator between an element associated with the armature and an element associated with one of the stators. The spring os in tension when the armature is at the first end of travel and in compression when the armature is at the second end of travel.

The first side stator, the second side stator, the first face stator, and the second face stator include a plurality of back iron sections having at least four recesses defined therein, a first side stator coil disposed in a first of the recesses, a second side stator coil disposed in a second of the recesses, a first face stator coil disposed in a third of the recesses, and a second face stator coil disposed in a fourth of the recesses. The back irons of the first and second side stators are one of: contiguous and continuous.

The apparatus includes a position sensor that senses position of the reciprocating component, an electronic control unit (ECU) electronically coupled to the position sensor, and a power electronics module electronically coupled to the ECU and electrically coupled to the side and face coils. The ECU commands the power electronics module to provide current to the coils based at least on a signal from the position sensor.

The armature is one of a permanent magnet and a ferromagnetic material.

Also disclosed is a thermodynamic apparatus that includes: a first cylinder having a central axis, a second cylinder have a central axis wherein the central axis of the first cylinder is parallel to the central axis of the second cylinder, a first displacer disposed in the first cylinder, a second displacer disposed in the second cylinder, a first shaft coupled to the first displacer, a second shaft coupled to the second displacer, and a first linear actuation system. The first linear actuation system has a first armature coupled to the first shaft. The first armature has a first end of travel delimited by a first face stator and a second end of travel delimited by a second face stator. A path of travel from the first end to the second end is parallel to the central axis of the first cylinder. The first linear actuation system also has a first side stator disposed between the first and second face coils. The first side stator has an inner diameter greater than an outer diameter of the first armature. The thermodynamic apparatus also includes a second linear actuation system. The second linear actuation system has a second armature coupled to the second shaft. The second armature has a first end of travel delimited by a third face stator and a second end of travel delimited by a fourth face stator. A path of travel from the first end of travel of the second armature to the second end of travel of the second armature is parallel to the central axis of the second cylinder. The second linear actuator further includes a second side stator disposed between the third and fourth face coils. The second side stator has an inner diameter greater than an outer diameter of the second armature. In some embodiments, the central axis of the first cylinder and the central axis of the second cylinder and collinear.

The apparatus also includes a third side stator disposed between the first and second face coils. The third side stator has an inner diameter greater than the outer diameter of the first armature. The third side stator is displaced from the first side stator in a direction along the central axis of the first cylinder. The apparatus also has a fourth side stator disposed between the third and fourth face coils. The fourth side stator has an inner diameter greater than the outer diameter of the second armature. The fourth side stator is displaced from the second side stator in a direction along the central axis of the second cylinder.

The first armature is indirectly coupled to the first shaft and the second armature is indirectly coupled to the second shaft. The apparatus further includes a first yoke coupled between the first armature and the first shaft and a second yoke coupled between the second armature and the second shaft.

The apparatus also has: a first compression spring disposed within the first linear actuator and exerting a force pushing the first armature away from the first face stator, a second compression spring disposed within the first linear actuator and exerting a force pushing the first armature away from the second face stator, a third compression spring disposed within the second linear actuator and exerting a force pushing the second armature away from the third face stator, and a fourth compression spring disposed within the second linear actuator and exerting a force pushing the second armature away from the fourth face stator.

In an alternative embodiment, the apparatus further includes: a first compression-tension spring disposed within the first linear actuator between an element associated with the first armature and an element directly or indirectly coupled to the first face stator. The first spring is in tension when the first armature is at its first end of travel and in compression when the first armature is at its second end of travel. The apparatus also has a second compression-tension spring disposed with the second linear actuator between an element associated with the second armature and an element directly or indirectly coupled to the third face stator. The second spring is in tension when the second armature is at its first end of travel and in compression when the second armature is at its second end of travel.

Each of the first side stator, the second side stator and the first, second, third, and fourth face stators have a back iron with at least one recess defined therein and a coil disposed in the recess.

The back iron of the first side stator has multiple recesses along its length with first side coils disposed within the recesses and the back iron of the second side stator has multiple recesses along its length with second side coils disposed within the recesses.

The thermodynamic apparatus also includes: a first position sensor that senses the position of the first displacer, a second position sensor that senses the position of the second displacer, and an electronic control unit (ECU) electronically coupled to the first position sensor and the second position sensor. A power electronics module is electronically coupled to the ECU and electrically coupled to a first coil associated with the first face stator, a second coil associated with the second face stator, a third coil associated with the third face stator, a fourth coil associated with the fourth face stator, a fifth coil associated with the first side stator, a sixth coil associated with the second side stator, a seventh coil associated with the third side stator, and an eighth coil associated with the fourth side stator. The ECU commands the power electronics module to provide current to the coils based at least on a signal from the position sensor.

The thermodynamic apparatus is a heat pump. The first displacer is a hot displacer that delimits a hot chamber and a hot-warm chamber with a gaseous working fluid disposed within the hot and hot-warm chambers. The second displacer is a cold displacer that delimits a cold chamber and a cold-warm chamber with the gaseous working fluid disposed within the cold and cold-warm chambers. Reciprocation of the hot displacer changes volume in the hot and hot-warm chambers. Reciprocation of the cold displacer changes volume in the cold and cold-warm chambers.

### BRIEF DESCRIPTION OF DRAWINGS

FIG. 1 is a schematic of an actuation system for a displacer of a gas-fired heat pump according to the prior art;

FIG. 2 is a schematic of a linear actuation system of the type in FIG. 1 with one linearly moving component, i.e., a single displacer;

FIG. 3 is a graph of the force of a coil on attracting an armature as a function of gap between the two;

FIG. 4 is an illustration of a linear actuation system for a single linearly moving component according to the present disclosure;

FIGS. 5 and 6 show a portion of a heat pump showing linear actuators applied to two displacers according to embodiments of the present disclosure; and

FIG. 7 is an illustration of the configuration of multiple linear actuators similar to the configuration in FIGS. 5 and 6.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

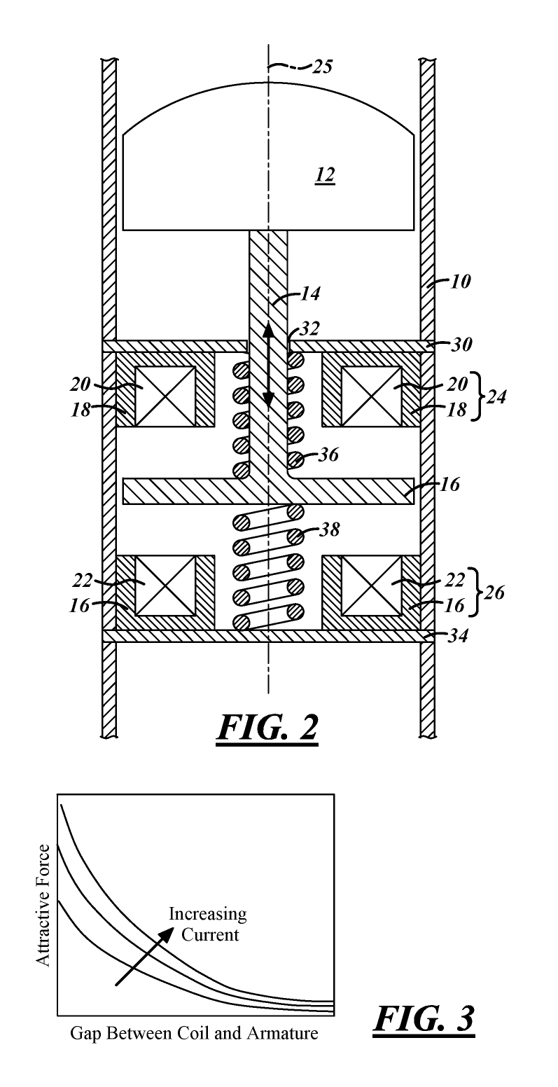

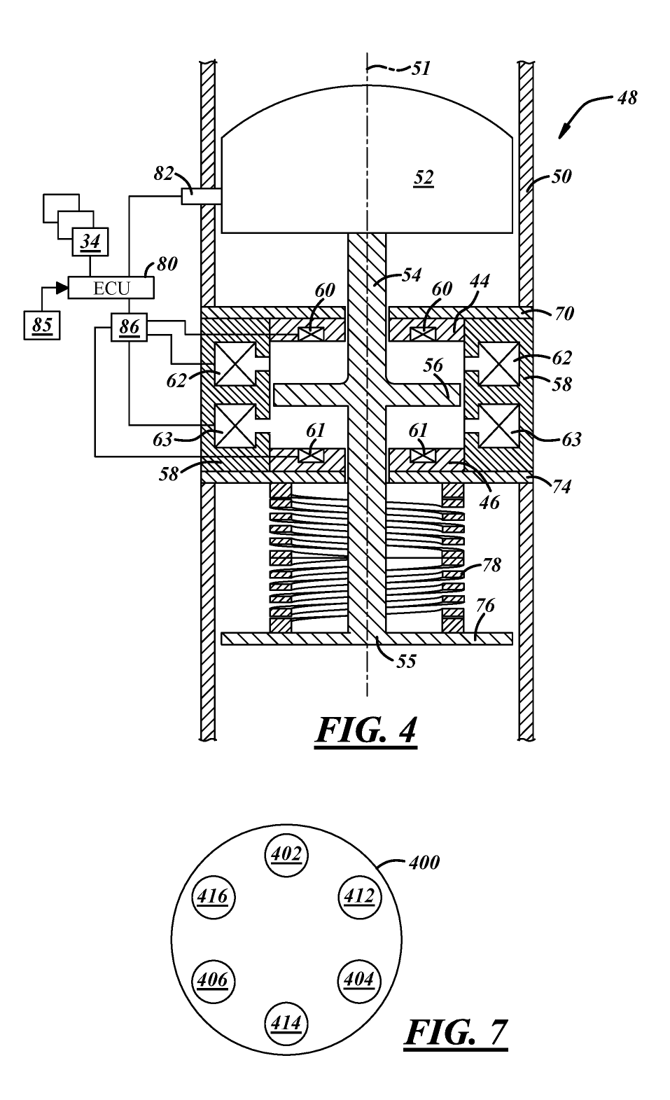

A linear actuator system 48 system is shown FIG. 4 in cross section. A displacer 52, or other member, reciprocates within a cylinder 50 that has a centerline 51. Displacer 52 is coupled to a shaft 54 that has an armature 56 (or plate) that extends outwardly from post 54. A shaft 55 extends from armature 56 in an opposite direction than shaft 54. Bridges 70 and 74 extend across cylinder 50 and define a volume in which back irons 44, 46, and 58 are disposed. An upper coil 60 is disposed within a recess in back iron 44; and a lower coil 61 is disposed within a recess in back iron 46. Back iron 44 and coil 60 form a first face stator; coil 61 and back iron 46 form a second face stator. Back iron 58 with coils 62 and 63 form side stators. The face stators in FIG. 4 are similar to the face stators shown in FIG. 2, although the former can be much smaller due to the side stators. Coils 60 and 61 act on armature 56 predominantly along central axis 51. Side coils 62 and 63 act upon armature 56 more effectively during mid-travel when armature 56 is closer to side coils 62 and 63. In FIG. 4, face coils 60 and 61 are much smaller than side coils 62 and 63 because face coils 60 and 61 no longer solely responsible for attracting armature 56. Instead, face coils 60 and 61 are largely responsible for holding armature 56 at the upper end and lower end of travel, respectively.

If movement of the displacer system (displacer 52, shaft 54, armature 56, shaft 55, and plate 76, which is coupled to shaft 55) were driven solely by activating coils 60, 61, 62, and 63, the electrical draw can be very high. Much of the force to move the displacer system is provided by a spring 78 which is affixed to bridge 74, which is in turn affixed to cylinder 50, and affixed to plate 76 which moves within cylinder 50. When armature 56 is at the top of travel, i.e., proximate coil 60, spring 68 is in compression. When armature 56 is at the bottom of travel, i.e., proximate face coil 61, spring 68 is in tension. Consequently, when armature 56 is at the top of travel, spring 68 pushes on plate 76 to cause displacer 52 to move downward when coil 60 is deactivated. And, when armature 56 is at the bottom of travel, spring 68 pulls upward on plate 76 to cause displacer 52 to move upward when coil 61 is deactivated. Spring 68 provides much of the force to move the displacer system between ends of travel. The force provided by spring 68 cannot be controlled. Side coils 62 and 63 provide additional force during travel, such force being controllable to ensure completing the travel and approaching the end of travel slowly enough to avoid impact.

In FIG. 4, an electronic control unit (ECU) 80 is electronically coupled to a position sensor and other sensors 84 that may include pressure, temperature, or humidity sensors, as examples. Furthermore, ECU 80 may be provided user input 85, such as a desired output from system 48. ECU 80 provides a signal or signals to a power electronics module 86 that is electrically coupled to coils 60, 61, 62, provided to control the current flow to coils 60, 61, 62, and 63 to obtain the desired travel of displacer 52. The ECU 80 signals to power electronics module 86 are based on one or more of user input, a signal from position sensor 82, and signals from other sensors 84.

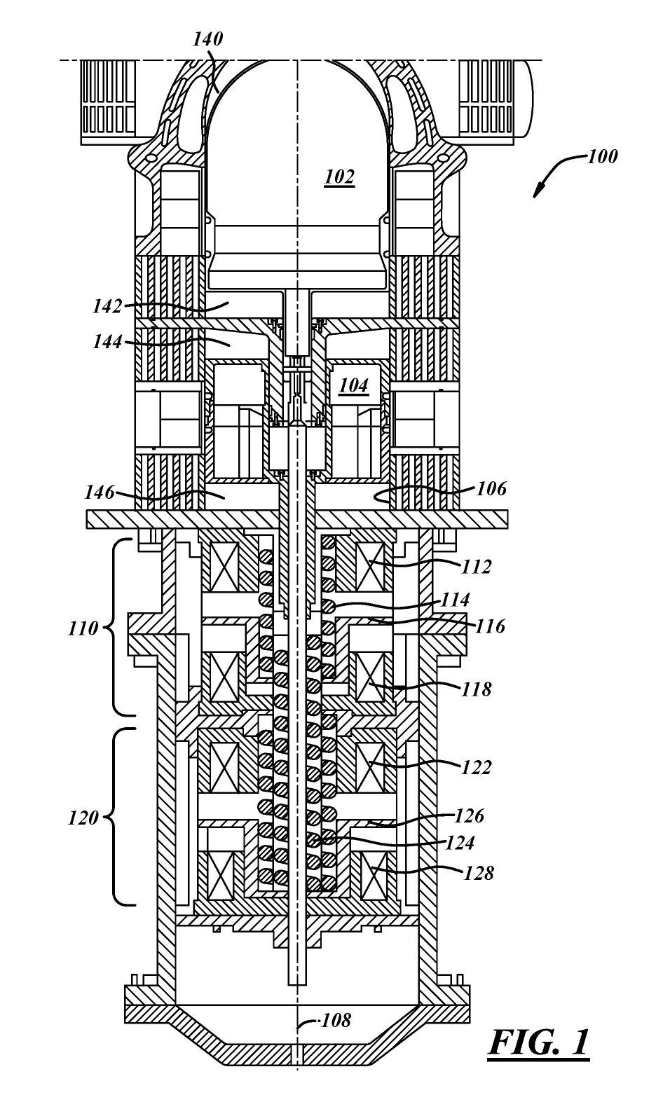

FIG. 4 is for illustrative purposes only. To use such a linear actuator in a heat pump similar to that in FIG. 1, two independently-actuated displacers are disposed in the cylinder each having at least two face coils, at least two side coils, and either a compression-tension spring or two compression springs acting in opposition. As shown in FIG. 4, spring 78 is remote from armature 56. In an alternative embodiment, spring 78 is disposed within back iron 58.

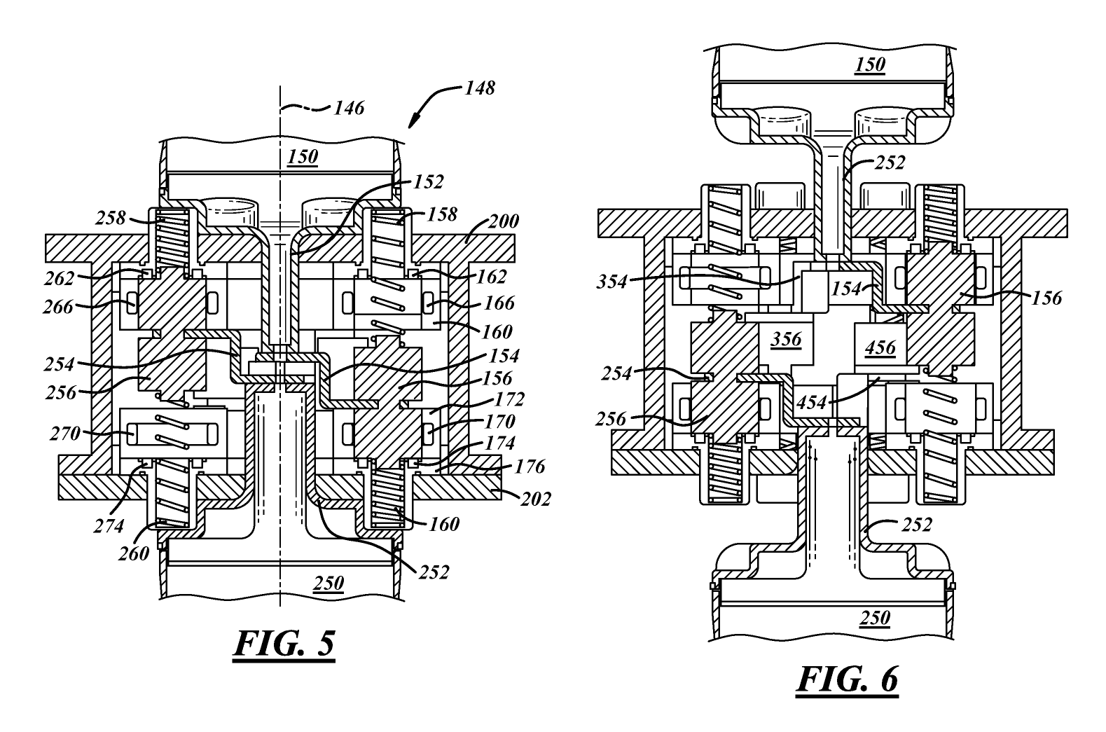

A portion of an embodiment of such a heat pump 148 that has two displacers is shown in cross section in FIG. 5. A displacer 150 (cylinder in which displacer 150 reciprocates not shown in FIG. 5). Displacer 150 is coupled to a shaft 152. Shaft 152 is coupled to a linear actuation system via a yoke 154. Yoke 154 couples directly to an armature 156 that is made of a ferromagnetic material or is a permanent magnet. In an electric motor, there is conventionally a rotor that rotates and a stator. Herein, the term stator is used for the stationary part. Armature 156 is acted upon by face stators, an upper face stator associated with displacer 150 includes a coil 162 disposed in a recess in back iron 164. A lower face stator associated with displacer 150 includes a coil 174 disposed in a recess in a back iron 176. Displacer 150 is shown at a lower end of travel and is proximate the lower face stator. Armature 156 is also acted upon by an upper side stator that includes a coil 166 disposed in a recess or cavity in back iron 168 and by a lower side stator that includes a coil 170 disposed in a recess in back iron 176. A compression spring 158 presses downwardly on armature 156 and a compression spring 160 presses upwardly on armature 156.

A second displacer system is also shown in FIG. 5. A displacer 250 (cylinder in which displacer 250 reciprocates not shown in FIG. 5). Displacer 250 is coupled to a shaft 252. Shaft 252 is coupled to a linear actuation system via a yoke 254. Yoke 254 couples directly to an armature 256 that is made of a ferromagnetic material or is a permanent magnet Armature 256 is acted upon by face stators, an upper face stator associated with displacer 250 includes a coil 262 disposed in a recess in back iron 264. A lower face stator associated with displacer 250 includes a coil 274 disposed in a recess in a back iron 276. Displacer 250 is shown at an upper end of travel and is proximate the upper face stator. Armature 256 is also acted upon by an upper side stator that includes a coil 266 disposed in a recess or cavity in back iron 268 and by a lower side stator that includes a coil 270 disposed in a recess in back iron 276. A compression spring 258 presses downwardly on armature 256 and a compression spring 260 presses upwardly on armature 256.

The linear actuation components are contained within a mechatronic housing 200 with a base plate 202. Mechatronic housing 200 and base plate 202 have openings to accommodate shafts 152 and 252 and other components.

In FIG. 5, displacers 150 and 250 are shown in the position in which they are the closest. Displacers 150 and 250 are shown in the position in which they are farthest apart in FIG. 6, i.e., in the opposite end of travel as that shown in FIG. 5.

In FIGS. 5 and 6, armatures 156 and 256 are shown offset from a central axis 146 along which displacers 150 and 152 reciprocate. In such a configuration, six armatures are provided in mechatronic housing 200, three of which couple to displacer 150 and three of which couple to displacer 250. In FIG. 6, armature 256 coupled via yoke 254 to shaft 252 of displacer 250 is show in cross section. Another armature 456 couples to shaft 252 of displacer 250. Similarly, armature 156 is coupled via yoke 154 to shaft 152 of displacer 150, also shown in cross section. Additionally, an armature 356 couples to shaft 152 of displacer 150 via a yoke 354. In FIG. 7, an arrangement is shown in which a mechatronic housing 400 has three armatures 402, 404, and 406 couple to a first displacer and armatures 412, 414, and 416 couple to a second displacer. The embodiments in FIGS. 5-7 show multiple armatures for each displacer and with the armatures offset from the centerline. In an alternate embodiment, each displacer is provided with a single armature. In other embodiments, the armatures are located along the central axis of the cylinder. In one embodiment, yokes 154 and 354 are coupled and are simply two legs of a single yoke. Similar situation with yokes 254 and 454. Alternatively, they are separate yokes that couple independently between the displacer shaft and their respective armature.

In FIG. 4, coil 60 is contained in back iron 44, coils 62 and 63 in a back iron 58, and coil 61 in back iron 46. In another embodiment, all of back irons 44, 46, and 58 are available in one continuous piece. In yet another embodiment, instead of back iron 58 being one single piece with two recesses to accommodate coils 62 and 63, it is made up of two pieces, one with a recess for coil 62 and one with a recess for coil 63. Herein, a reference to a back iron refers to a single continuous piece and to more than one contiguous piece. Also, when reference is made to first and second contiguous back irons, it also refers to a single, continuous back iron.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. A linear actuator, comprising:
a substantially cylindrical back iron section having a central axis, the back iron section having at least first and second recesses defined therein, with the first recess displaced from the second recess in a direction parallel to the central axis;
an armature disposed within the back iron, the armature being free to move along the central axis between a first end of travel and a second end of travel;
a first face stator delimiting the first end of travel of the armature;
a second face stator delimiting the second end of travel of the armature;
the back iron section having inner dimensions that allow the armature to pass therethrough wherein:
a first side coil is disposed in the first recess; and
a second side coil is disposed in the second recess.

2. The linear actuator of claim 1, further comprising: a shaft coupled to the armature with a central axis of the shaft parallel to the central axis of the substantially cylindrical back iron section.

3. The linear actuator of claim 1, further comprising:
a first compression spring disposed within the linear actuator and exerting a force between the armature and the back iron section with the force acting in a direction parallel to the central axis; and
a second compression spring disposed within the linear actuator and exerting a force between the armature and the back iron section with the force acting in a direction parallel to the central axis and opposed to the force exerted by the first compression spring.

4. The linear actuator of claim 1, further comprising:
a spring indirectly coupled between the armature and the back iron section, the spring being in compression when the armature is at the first end of travel and being in tension when the armature is at the second end of travel.

5. The linear actuator of claim 1 wherein: the first and second face stators each comprise a face back iron section having a recess therein and a face coil disposed within the recess.

6. The linear actuator of claim 1 wherein the armature is comprised of one of: a ferromagnetic material and a permanent magnet.

7. An apparatus, comprising:
a cylinder having a central axis;
a reciprocating component disposed in the cylinder;
a shaft coupled to the reciprocating component; and
a linear actuation system, comprising:
an armature coupled to the shaft, the armature having a first end of travel delimited by a first face stator and a second end of travel delimited by a second face stator, a path of travel from the first end to the second end being parallel to the central axis of the cylinder; and
first and second side stators disposed between the first and second face coils, the side stators having an inner diameter greater than an outer diameter of the armature.

8. The apparatus of claim 7 wherein the armature is indirectly coupled to the shaft, the apparatus further comprising:
a yoke coupled between the armature and the shaft.

9. The apparatus of claim 7, further comprising:
a first compression spring disposed within the linear actuator and exerting a force pushing the armature away from the first face stator;
a second compression spring disposed within the linear actuator and exerting a force pushing the armature away from the second face stator.

10. The apparatus of claim 7, further comprising:
a compression-tension spring disposed within the linear actuator between an element associated with the armature and an element associated with at least one of the stators, the spring being in tension when the armature is at the first end of travel and in compression when the armature is at the second end of travel.

11. The apparatus of claim 7 wherein the first and second side stators and the first and second face stators comprise:
a plurality of back iron sections having at least four recesses defined therein;
a first side stator coil disposed in a first of the recesses;
a second side stator coil disposed in a second of the recesses;
a first face stator coil disposed in a third of the recesses; and
a second face stator coil disposed in a fourth of the recesses, wherein:
the back iron sections in which the first and second side stator coils are disposed are one of: contiguous and continuous.

12. The apparatus of claim 11, further comprising:
a position sensor that senses position of the reciprocating component;
an electronic control unit (ECU) electronically coupled to the position sensor; and
a power electronics module electronically coupled to the ECU and electrically coupled to the side and face coils wherein the ECU commands the power electronics module to provide current to the coils based at least on a signal from the position sensor.

13. The apparatus of claim 7 wherein the armature is one of a permanent magnet and a ferromagnetic material.

14. A thermodynamic apparatus, comprising:
a first cylinder having a central axis;
a second cylinder have a central axis;
a first displacer disposed in the first cylinder;
a second displacer disposed in the second cylinder;
a first shaft coupled to the first displacer;
a second shaft coupled to the second displacer;
a first linear actuation system, comprising:
a first armature coupled to the first shaft, the first armature having a first end of travel delimited by a first face stator and a second end of travel delimited by a second face stator, a path of travel from the first end to the second end being parallel to the central axis of the first cylinder; and
a first side stator disposed between the first and second face coils, the first side stator having an inner diameter greater than an outer diameter of the first armature; and
a second linear actuation system, comprising:
a second armature coupled to the second shaft, the second armature having a first end of travel delimited by a third face stator and a second end of travel delimited by a fourth face stator, a path of travel from the first end of travel of the second armature to the second end of travel of the second armature being parallel to the central axis of the second cylinder; and
a second side stator disposed between the third and fourth face coils, the second side stator having an inner diameter greater than an outer diameter of the second armature.

15. The thermodynamic apparatus of claim 14, further comprising:
a third side stator disposed between the first and second face coils, the third side stator having an inner diameter greater than the outer diameter of the first armature, the third side stator being displaced from the first side stator in a direction along the central axis of the first cylinder; and
a fourth side stator disposed between the third and fourth face coils, the fourth side stator having an inner diameter greater than the outer diameter of the second armature, the fourth side stator being displaced from the second side stator in a direction along the central axis of the second cylinder.

16. The thermodynamic apparatus of claim 14, further comprising:
a first compression spring disposed within the first linear actuator and exerting a force pushing the first armature away from the first face stator;
a second compression spring disposed within the first linear actuator and exerting a force pushing the first armature away from the second face stator;
a third compression spring disposed within the second linear actuator and exerting a force pushing the second armature away from the third face stator; and
a fourth compression spring disposed within the second linear actuator and exerting a force pushing the second armature away from the fourth face stator.

17. The thermodynamic apparatus of claim 14, further comprising:
a first compression-tension spring disposed within the first linear actuator between an element associated with the first armature and an element coupled, one of directly or indirectly, to the first face stator, the first spring being in tension when the first armature is at its first end of travel and in compression when the first armature is at its second end of travel; and
a second compression-tension spring disposed with the second linear actuator between an element associated with the second armature and an element coupled, one of directly or indirectly, to the third face stator, the second spring being in tension when the second armature is at its first end of travel and in compression when the second armature is at its second end of travel.

18. The thermodynamic apparatus of claim 15 wherein the first and third side stators and the first and second face stators comprise:
a plurality of back iron sections having at least four recesses defined therein;
a first side stator coil disposed in a first of the recesses;
a third side stator coil disposed in a second of the recesses;
a first face stator coil disposed in a third of the recesses; and
a second face stator coil disposed in a fourth of the recesses, wherein:
the back iron sections in which the first and third side stator coils are disposed are one of: contiguous and continuous.

19. The thermodynamic apparatus of claim 15, further comprising:
a first position sensor that senses the position of the first displacer;
a second position sensor that senses the position of the second displacer;
an electronic control unit (ECU) electronically coupled to the first position sensor and the second position sensor; and
a power electronics module electronically coupled to the ECU and electrically coupled to:
a first coil associated with the first face stator;
a second coil associated with the second face stator;
a third coil associated with the third face stator;
a fourth coil associated with the fourth face stator;
a fifth coil associated with the first side stator;
a sixth coil associated with the second side stator;
a seventh coil associated with the third side stator; and
an eighth coil associated with the fourth side stator;
wherein the ECU commands the power electronics module to provide current to the coils based at least on a signal from the position sensor.

20. The thermodynamic apparatus of claim 14, wherein:
the thermodynamic apparatus is a heat pump;
the first displacer is a hot displacer that delimits a hot chamber and a hot-warm chamber with a gaseous working fluid disposed within the hot and hot-warm chambers;
the second displacer is a cold displacer that delimits a cold chamber and a cold-warm chamber with the gaseous working fluid disposed within the cold and cold-warm chambers;
reciprocation of the hot displacer changes volume in the hot and hot-warm chambers; and
reciprocation of the cold displacer changes volume in the cold and cold-warm chambers.
